(19) United States
(12) Patent Application Publication
(10) Pub. No.: US 2025/0202991 A1
(43) Pub. Date: Jun. 19, 2025

(54) LOCATION PACKET PROVIDING APPARATUS AND METHOD

(71) Applicant: Getac Technology Corporation, New Taipei City (TW)

(72) Inventors: Yen-Hsiang HUNG, Taipei City (TW); Chun-Hui LIN, Taipei City (TW)

(21) Appl. No.: 18/883,395

(22) Filed: Sep. 12, 2024

(30) Foreign Application Priority Data
Dec. 14, 2023 (CN) 202311727728.X

(51) Int. Cl. H04L 67/52; H04W 64/00

(52) U.S. Cl. CPC H04L 67/52; H04W 64/006

(57) ABSTRACT

A location packet providing apparatus and method are provided. The apparatus receives positioning data from the positioning unit continuously. In response to the positioning data received over a first time period reaching a first packet length, the apparatus transmits a first positioning packet with the first packet length to an application via a virtual port, wherein the first positioning packet includes the positioning data received over the first time period. The apparatus generates a second positioning packet corresponding to a second packet length based on the positioning data received over a second time period, wherein the second packet length corresponds to the application connected by the virtual port, and the second time period is different from the first time period.

### CROSS-REFERENCE TO RELATED APPLICATION

This application claims priority to China Application Serial Number 202311727728.X, filed Dec. 14, 2023, which is herein incorporated by reference in its entirety.

### BACKGROUND

### Field of Invention

The present disclosure relates to a location packet providing apparatus and method. More particularly, the present disclosure relates to a location packet providing apparatus and method for adjusting packet lengths.

### Description of Related Art

Currently, on mobile devices (e.g., laptops, tablets, mobile phones), many applications need to use the location information of the device. Applications can request packets containing location information by communicating with the driver of the location component, the operating system of the device, and/or the firmware. However, each application may have different specification requirements for location packets, and the frequency of requesting location packets may also vary. This situation may cause applications to lose packets and fail to obtain complete location information.

In view of this, how to adjust the length of location packets and provide them to applications is a goal that the industry strives to work on.

### SUMMARY

The disclosure provides a location packet providing apparatus including a positioning unit and a processor. The processor is electrically connected to the positioning unit and configured to execute the following operations: receiving a plurality of first positioning data from the positioning unit continuously; in response to the first positioning data received over a first time period reaching a first packet length, transmitting a first positioning packet with the first packet length to a first application via a first virtual port among at least one virtual port, wherein the first positioning packet includes the first positioning data received over the first time period; and generating a second positioning packet corresponding to a second packet length based on the first positioning data received over a second time period, wherein the second packet length corresponds to the first application connected by the first virtual port, and the second time period is different from the first time period.

The disclosure further provides a location packet providing method, being adapted for use in a processor, wherein the location packet providing method includes the following steps: receiving a plurality of first positioning data from a positioning unit continuously; in response to the first positioning data received over a first time period reaching a first packet length, transmitting a first positioning packet with the first packet length to a first application via a first virtual port among at least one virtual port, wherein the first positioning packet includes the first positioning data received over the first time period; and generating a second positioning packet corresponding to a second packet length based on the first positioning data received over a second time period, wherein the second packet length corresponds to the first application connected by the first virtual port, and the second time period is different from the first time period.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a location packet providing apparatus according to a first embodiment of the present disclosure.

FIG. 2 is a schematic diagram illustrating a packet interface according to some embodiments of the present disclosure.

FIG. 3 is a schematic diagram illustrating a user interface according to some embodiments of the present disclosure.

FIG. 4 is a schematic diagram illustrating another user interface according to some embodiments of the present disclosure.

FIG. 5 is a flow diagram illustrating a location packet providing method according to a second embodiment of the present disclosure.

FIGS. 6-9 are flow diagrams illustrating details of the location packet providing method according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

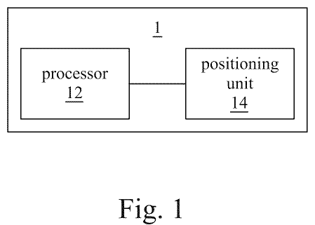

Please refer to FIG. 1, which is a schematic diagram illustrating a location packet providing apparatus 1 according to a first embodiment of the present disclosure. The location packet providing apparatus 1 includes the processor 12 and the positioning unit 14, wherein the processor 12 electrically connects to the positioning unit 14. The location packet providing apparatus 1 is configured to adjust the length of a positioning packet to provide the positioning packet with a suitable length to an application.

In some embodiments, the processor 12 includes a central processing unit (CPU), a graphics processing unit (GPU), a multi-processor, a distributed processing system, an application specific integrated circuit (ASIC), and/or a suitable processing unit.

The positioning unit 14 is configured to generate the positioning data of the location packet providing apparatus 1. In some embodiments, the positioning unit 14 may include a Global Positioning System (GPS) receiver.

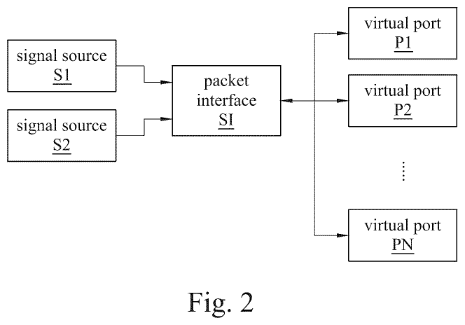

In some embodiments, when a Global Positioning System module is taken as the positioning unit 14, the positioning unit 14 may only output positioning data via a single output port to an application or an operating system due to specification limits. However, when there are multiple applications that need to obtain positioning data, the processor 12 of the location packet providing apparatus 1 provides a packet interface. Please refer to FIG. 2, which is a schematic diagram illustrating a packet interface SI according to some embodiments of the present disclosure.

As shown in FIG. 2, the packet interface SI receives positioning data from signal sources S1 and S2. Furthermore, the packet interface SI creates packets from the positioning data and transmits the positioning packet to one or more applications and/or operating systems via virtual ports P1-PN (e.g., COM port).

It is noted that, the numbers of the signal sources and virtual ports shown in FIG. 2 are used for illustration. In practice, the location packet providing apparatus 1 includes one or more signal sources and virtual ports, and the numbers of the signal sources and virtual ports may be adjusted as needed.

First, the processor 12 of the location packet providing apparatus 1 receives a plurality of first positioning data from the positioning unit 14 continuously.

Next, in response to the first positioning data received over a first time period reaching a first packet length, the processor 12 of the location packet providing apparatus 1 transmits a first positioning packet with the first packet length to a first application via a first virtual port among at least one virtual port, wherein the first positioning packet includes the first positioning data received over the first time period.

Finally, the processor 12 of the location packet providing apparatus 1 generates a second positioning packet corresponding to a second packet length based on the first positioning data received over a second time period, wherein the second packet length corresponds to the first application connected by the first virtual port, and the second time period is different from the first time period.

Specifically, when the location packet providing apparatus 1 is operating, the positioning unit 14 receives positioning signals (e.g., Global Positioning System signals) continuously and passes the content of the positioning signals (i.e., the first positioning data) to the processor 12. Correspondingly, the processor 12 then determines the data length of the first positioning data continuously.

Furthermore, when the positioning data received by the processor 12 reaches a certain length (e.g., 64 bytes) (i.e., the first packet length), the processor 12 creates a positioning packet (i.e., the first positioning packet) from the received positioning data and transmits the positioning packet to the first application. Accordingly, the positioning packet will have the first packet length. In contrast, if the positioning data received by the processor 12 does not reach the first packet length, the processor 12 may not create the first positioning packet and continues to determine the data length of the received first positioning data.

However, when the packet length required by the first application and the first packet length are different, the location packet providing apparatus 1 transmits positioning packets with a second packet length instead. Similarly, when the positioning data received by the processor 12 reaches the second packet length (e.g., 32 bytes), the processor 12 creates a positioning packet (i.e., the second positioning packet) from the received positioning data and transmits the positioning packet to the first application. Accordingly, the positioning packet has the second packet length and matches the requirement of the first application.

It is noted that, since the positioning packet includes not only positioning data, but also other functional data such as header, the aforementioned first packet length and second packet length may be adjusted according to the actual situation. For example, if the packet length is set as 64 bytes, and the packet includes a 2-byte header, then the processor 12 creates the positioning packet from the positioning data once the received positioning data reaches 62 bytes.

In some embodiments, the positioning packet (e.g., the first positioning packet or the second positioning packet) consists of the standard format proposed by National Marine Electronics Association (NMEA).

In some embodiments, the operation of the processor 12 transmitting the first positioning packet to the first application further includes: in response to the first positioning data received over the first time period reaching the first packet length and receiving a packet request from the first application, the processor 12 transmitting the first positioning packet to the first application via the first virtual port.

Accordingly, after the positioning data received by the processor 12 reaches a certain length (the first or second packet length), and the processor 12 creates the positioning packet from the positioning data. If the application requests a positioning packet from the processor 12 at this time, the processor 12 may transmit the completed positioning packet to the application via the virtual port corresponding to the application.

In some embodiments, the operation of the processor 12 transmitting the first positioning packet to the first application further includes: the processor 12 filtering out redundant data from the first positioning data based on a data setting; and the processor 12 generating the first positioning packet based on the filtered first positioning data.

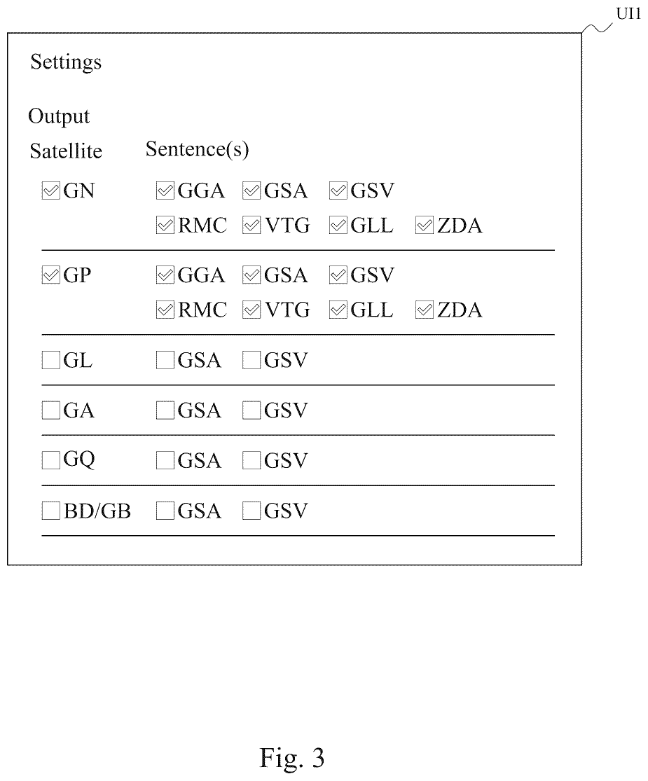

For example, please refer to FIG. 3. The location packet providing apparatus 1 provides a user interface UI1, and multiple satellite positioning signal sources provided by the positioning unit 14 and the positioning signal contents provided by each of the multiple satellite positioning signal sources are listed in the user interface UI1. The user may select the data content needed to be included in the positioning packet via the user interface UI1. Furthermore, the processor 12 filters out unchecked data (i.e., the redundant data) from the first positioning data and only reserves the selected data based on the item(s) checked by the user (i.e., the data setting). Correspondingly, the processor 12 creates the positioning packet from the reserved positioning data.

It is noted that, the processor 12 may determine whether the positioning data reaches the packet length based on the filtered positioning data. Accordingly, the processor 12 is able to generate packets with specific length based on the filtered positioning data.

In some embodiments, the operation of the processor 12 generating the second positioning packet further includes: in response to the first positioning data received over the first time period reaching the first packet length and receiving a packet request from the first application, the processor 12 generating the second positioning packet based on the first positioning data received over the second time period, wherein the second time period is later than the first time period.

In this embodiment, the processor 12 may generate multiple positioning packets sequentially, and each of the multiple positioning packets includes the positioning data received over different time periods.

In some embodiments, the processor 12 further obtains an amended packet length, wherein the amended packet length is determined based on the first application, and the amended packet length is different from the first packet length. The processor 12 determines the second packet length of the second positioning packet based on the amended packet length.

In some embodiments, the operation of the processor 12 obtaining the amended packet length further includes: the processor 12 generating a user interface, wherein the user interface includes a plurality of packet length options; and the processor 12 obtaining the amended packet length based on one of the packet length options selected in the user interface.

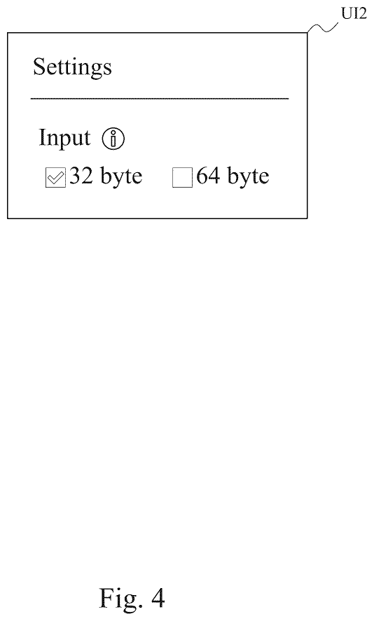

For example, please refer to FIG. 4. The location packet providing apparatus 1 may provide a user interface UI2, and the user is able to adjust the length of the positioning packet generated by the processor 12 via the user interface UI2. Namely, while the user changes the options in the user interface UI2, for example, by changing the check from 32 byte to 64 byte, the processor 12 determines the length of the subsequent positioning packet based on the amended packet length received (i.e., 64 byte).

Accordingly, the processor 12 is able to adjust the subsequent positioning packet length based on the amended packet length that is obtained to provide the corresponding packet length the application needed.

In some embodiments, the amended packet length is obtained in response to the first application determining the first packet length is a wrong length and the first application transmitting the amended packet length via the first virtual port.

For example, the location packet providing apparatus 1 also provides an application programming interface (API) to receive the amended packet length from the application. On the other hand, when determining that the application is not able to obtain positioning packets (e.g., data loss due to wrong packet lengths), the application is able to transmit the amended packet length needed via the application programming interface to the location packet providing apparatus 1.

In some embodiments, the operation of the processor 12 generating the second positioning packet further includes: in response to the first positioning data received over the second time period reaching the second packet length, the processor 12 transmitting the second positioning packet with the second packet length to the first application via the first virtual port, wherein the second positioning packet includes the first positioning data received over the second time period.

Accordingly, after obtaining enough positioning data and creating the second positioning packet, the processor 12 transmits the second positioning packet to the application through operations similar with the transmission of the first positioning packet.

In some embodiments, the processor 12 is further configured to receive a plurality of second positioning data from a positioning signal source continuously, and the operation of the processor 12 transmitting the first positioning packet to the first application further includes: in response to the first positioning data and the second positioning data received over the first time period reaching the first packet length, the processor 12 transmitting the first positioning packet with the first packet length to the first application via the first virtual port among the at least one virtual port, wherein the first positioning packet includes the first positioning data and the second positioning data received over the first time period.

For example, as shown in FIG. 2, signal sources S1 and S2 may be the positioning unit 14, operating system, and/or communication interfaces such as Wi-Fi or Bluetooth interface. Accordingly, the location packet providing apparatus 1 may generate the first positioning packet including positioning data from two or more positioning signal sources.

In some embodiments, the processor 12 further transmits a third positioning packet with a third packet length to a second application via a second virtual port among the at least one virtual port, and the third packet length is different from the second packet length.

For example, the virtual ports P1-PN may be configured to transmit positioning packets with different packet lengths, and the processor 12 distributes the virtual ports based on the packet length requirements of the applications and transmits the positioning packets via the corresponding virtual ports to the applications.

Accordingly, the location packet providing apparatus 1 is able to provide positioning packets with the corresponding packet lengths based on different application requirements.

In some embodiments, the virtual ports P1-PN shown in FIG. 2 may be N buffers and configured to store the positioning packets with different lengths generated by the processor 12, wherein N is a positive integer. Accordingly, when requesting a positioning packet, the application may access the corresponding virtual port based on its requirements to obtain the positioning packet with specific length.

Additionally, since the buffer space is limited, while generating a new positioning packet, the processor 12 overwrites the positioning packet originally stored in the virtual port with the new positioning packet. Accordingly, the longer the packet length corresponding to the virtual port, the longer the time required to update the positioning packet (i.e., the lower the update frequency). In contrast, the shorter the packet length corresponding to the virtual port, the shorter the time required to update the positioning packet (i.e., the higher the update frequency). Therefore, the application with a higher positioning packet update frequency may access the virtual port corresponding to a shorter packet length to obtain the positioning data with a higher update rate. The application with a lower positioning packet update frequency may access the virtual port corresponding to a longer packet length to avoid positioning data loss.

In summary, the location packet providing apparatus 1 provided by the present disclosure is able to provide the positioning packet that meets the requirement of the application, wherein the packet length can be updated via user interface or application programming interface. Also, the location packet providing apparatus 1 may transmit positioning packets with different packet lengths to different applications via multiple virtual ports. Accordingly, the location packet providing apparatus 1 is able to break through hardware limitations, provide positioning data for multiple applications simultaneously, and provide packets with different lengths based on the respective requirements of the applications.

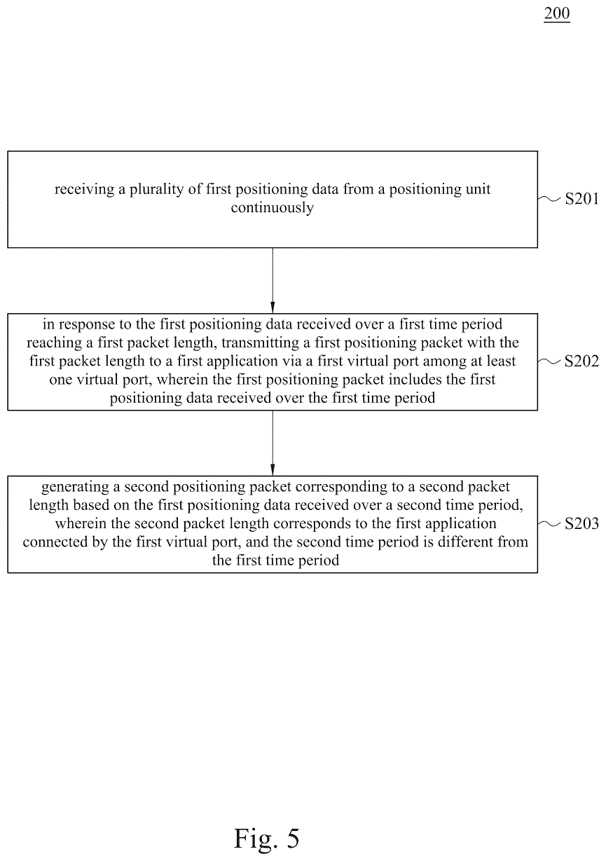

Please refer to FIG. 5, which is a flow diagram illustrating a location packet providing method 200 according to a second embodiment of the present disclosure. The location packet providing method 200 includes steps S201-S203. The location packet providing method 200 is configured to adjust the length of a positioning packet to provide the positioning packet with a suitable length to an application. The location packet providing method 200 can be executed by a processor (e.g., the processor 12 shown in FIG. 1). In some embodiments, the processor executes all of the operations and functions of the processor 12 in the first embodiment, and the relevant detail will not be repeated in this embodiment.

First, in the step S201, the processor receives a plurality of first positioning data from a positioning unit (e.g., the positioning unit 14 shown in FIG. 1) continuously.

Next, in the step S202, in response to the first positioning data received over a first time period reaching a first packet length, the processor transmits a first positioning packet with the first packet length to a first application via a first virtual port among at least one virtual port, wherein the first positioning packet includes the first positioning data received over the first time period. When the first positioning data received over the first time period has not reached the first packet length, the processor does not execute the step S202 and continues to execute the step S201.

Finally, in the step S203, the processor generates a second positioning packet corresponding to a second packet length based on the first positioning data received over a second time period, wherein the second packet length corresponds to the first application connected by the first virtual port, and the second time period is different from the first time period.

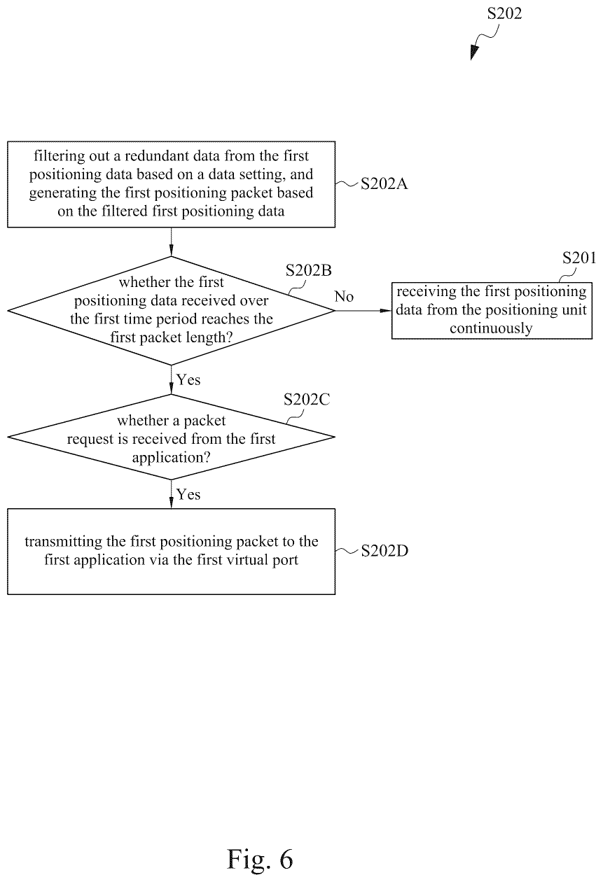

Please refer to FIG. 6, in some embodiments, the step S202 further includes steps S202A-S202D.

First, in the step S202A, the processor filters out redundant data from the first positioning data based on a data setting, and the processor generates the first positioning packet based on the filtered first positioning data.

Next, in the step S202B, the processor determines whether the first positioning data received over the first time period (i.e., the filtered first positioning data) reaches the first packet length.

At this time, in response to the processor determining that the first positioning data received over the first time period has not reached the first packet length, the processor returns to the step S201, receiving the first positioning data from the positioning unit continuously.

In response to the processor determining that the first positioning data received over the first time period has reached the first packet length, the processor executes the step S202C, determining whether a packet request is received from the first application.

Next, in response to receiving a packet request from the first application, the processor executes the step S202D, transmitting the first positioning packet to the first application via the first virtual port. If the packet request is not received from the first application, then the processor does not execute the step S202D.

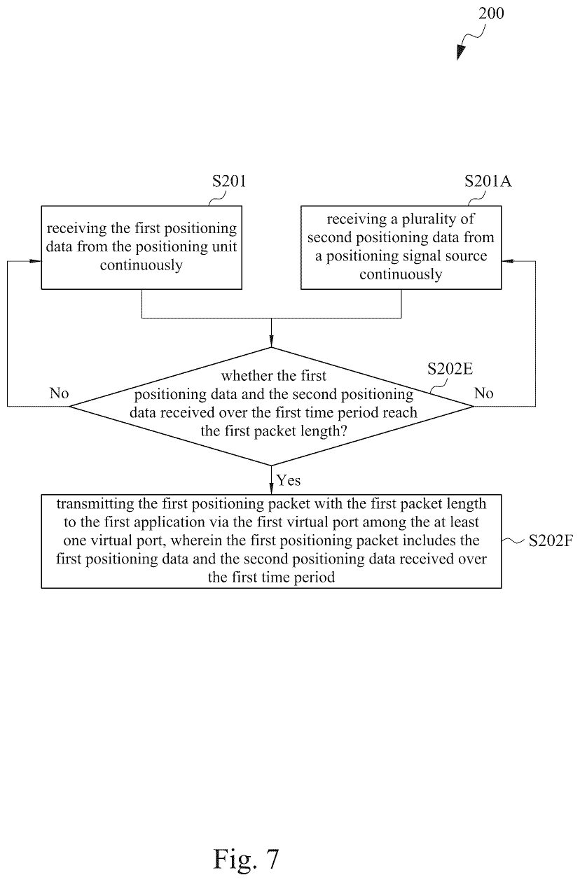

Please refer to FIG. 7, in some embodiments, the location packet providing method 200 further includes a step S201A, and the step S202 further includes steps S202E and S202F.

In this embodiment, the processor executes the steps S201 and S201A at the same time, and the steps S201 and S201A respective include receiving the first positioning data from the positioning unit continuously and receiving a plurality of second positioning data from a positioning signal source continuously.

Next, the processor executes the step S202E, determining whether the first positioning data and the second positioning data received over the first time period reach the first packet length.

At this time, in response to the processor determining that the first positioning data and the second positioning data received over the first time period do not reach the first packet length, the processor continues to execute the steps S201 and S201A.

In response to the processor determining that the first positioning data and the second positioning data received over the first time period have reached the first packet length, the processor executes the step S202F, transmitting the first positioning packet with the first packet length to the first application via the first virtual port among the at least one virtual port, wherein the first positioning packet includes the first positioning data and the second positioning data received over the first time period.

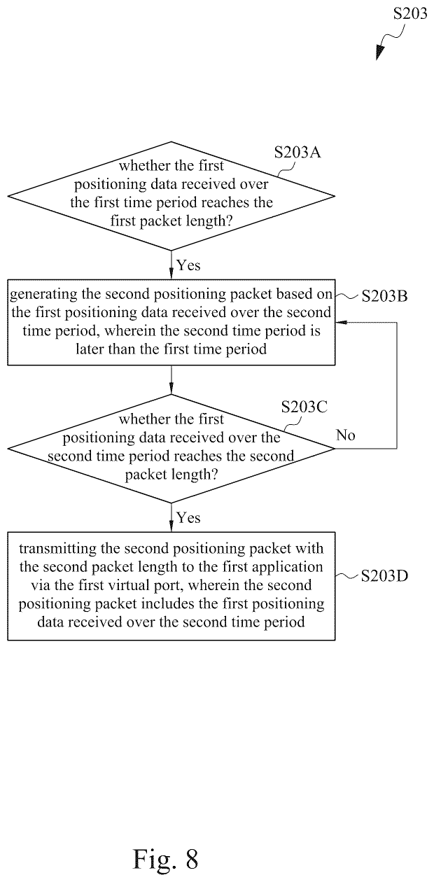

Please refer to FIG. 8, in some embodiments, the step S203 further includes steps S203A-S203D.

First, in the step S203A, the processor determines whether the first positioning data received over the first time period reaches the first packet length.

At this time, in response to the processor determining that the first positioning data received over the first time period has reached the first packet length, the processor executes the step S203B, generating the second positioning packet based on the first positioning data received over the second time period, wherein the second time period is later than the first time period. In response to the first positioning data received over the first time period not reaching the first packet length, the processor does not generate the second positioning packet.

Next, in the step S203C, the processor determines whether the first positioning data received over the second time period reaches the second packet length.

At this time, in response to the processor determining that the first positioning data received over the second time period reaches the second packet length, the processor executes the steps S203D, transmitting the second positioning packet with the second packet length to the first application via the first virtual port, wherein the second positioning packet includes the first positioning data received over the second time period.

In response to the processor determining that the first positioning data received over the second time period does not reach the second packet length, the processor returns to the step S203B.

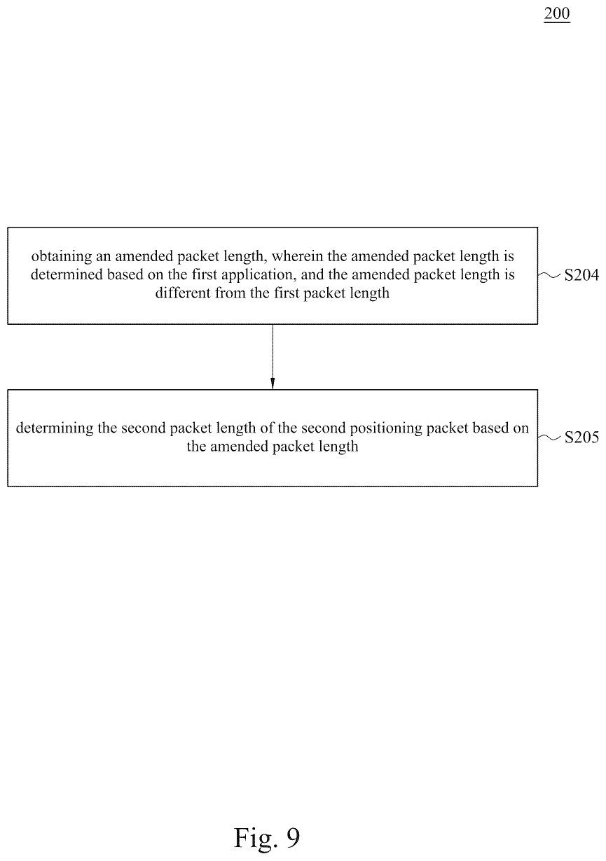

Please refer to FIG. 9, in some embodiments, the location packet providing method 200 further includes steps S204 and S205.

In the step S204, the processor obtains an amended packet length, wherein the amended packet length is determined based on the first application, and the amended packet length is different from the first packet length.

Next, in the step S205, the processor determines the second packet length of the second positioning packet based on the amended packet length.

In summary, the location packet providing method 200 provided by the present disclosure is able to provide the positioning packet that meets the requirements of the application, wherein the packet length can be updated via a user interface or an application programming interface. Also, the location packet providing method 200 may transmit positioning packets with different packet lengths to different applications via multiple virtual ports. Accordingly, the location packet providing method 200 is able to break through hardware limitations, provide positioning data for multiple applications simultaneously, and provide packets with different lengths based on the respective requirements of the applications.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A location packet providing apparatus, comprising:
a positioning unit; and
a processor electrically connected to the positioning unit, the processor configured to execute the following operations:
receiving a plurality of first positioning data from the positioning unit continuously;
in response to the first positioning data received over a first time period reaching a first packet length, transmitting a first positioning packet with the first packet length to a first application via a first virtual port among at least one virtual port, wherein the first positioning packet comprises the first positioning data received over the first time period; and
generating a second positioning packet corresponding to a second packet length based on the first positioning data received over a second time period, wherein the second packet length corresponds to the first application connected by the first virtual port, and the second time period is different from the first time period.

2. The location packet providing apparatus of claim 1, wherein the operation of transmitting the first positioning packet to the first application further comprises:
in response to the first positioning data received over the first time period reaching the first packet length and receiving a packet request from the first application, transmitting the first positioning packet to the first application via the first virtual port.

3. The location packet providing apparatus of claim 1, wherein the operation of transmitting the first positioning packet to the first application further comprises:
filtering out redundant data from the first positioning data based on a data setting to obtain filtered first positioning data; and
generating the first positioning packet based on the filtered first positioning data.

4. The location packet providing apparatus of claim 1, wherein the processor is further configured to receive a plurality of second positioning data from a positioning signal source continuously, and the operation of transmitting the first positioning packet to the first application further comprises:
in response to the first positioning data and the second positioning data received over the first time period reaching the first packet length, transmitting the first positioning packet with the first packet length to the first application via the first virtual port, wherein the first positioning packet comprises the first positioning data and the second positioning data received over the first time period.

5. The location packet providing apparatus of claim 1, wherein the operation of generating the second positioning packet further comprises:
in response to the first positioning data received over the first time period reaching the first packet length and receiving a packet request from the first application, generating the second positioning packet based on the first positioning data received over the second time period, wherein the second time period is later than the first time period.

6. The location packet providing apparatus of claim 1, wherein the operation of generating the second positioning packet further comprises:
in response to the first positioning data received over the second time period reaching the second packet length, transmitting the second positioning packet with the second packet length to the first application via the first virtual port, wherein the second positioning packet comprises the first positioning data received over the second time period.

7. The location packet providing apparatus of claim 1, wherein the processor is further configured to execute the following operations:
obtaining an amended packet length, wherein the amended packet length is determined based on the first application, and the amended packet length is different from the first packet length; and
determining the second packet length of the second positioning packet based on the amended packet length.

8. The location packet providing apparatus of claim 7, wherein the amended packet length is obtained in response to the first application determining the first packet length is a wrong length and the first application transmitting the amended packet length via the first virtual port.

9. The location packet providing apparatus of claim 7, wherein the operation of obtaining the amended packet length further comprises:
generating a user interface, wherein the user interface comprises a plurality of packet length options; and
obtaining the amended packet length based on one of the packet length options selected in the user interface.

10. The location packet providing apparatus of claim 1, wherein the processor is further configured to execute the following operation:
transmitting a third positioning packet with a third packet length to a second application via a second virtual port among the at least one virtual port, wherein the third packet length is different from the second packet length.

11. A location packet providing method, being adapted for use in a processor, wherein the location packet providing method comprises the following steps:
receiving a plurality of first positioning data from a positioning unit continuously;
in response to the first positioning data received over a first time period reaching a first packet length, transmitting a first positioning packet with the first packet length to a first application via a first virtual port among at least one virtual port, wherein the first positioning packet comprises the first positioning data received over the first time period; and
generating a second positioning packet corresponding to a second packet length based on the first positioning data received over a second time period, wherein the second packet length corresponds to the first application connected by the first virtual port, and the second time period is different from the first time period.

12. The location packet providing method of claim 11, wherein the step of transmitting the first positioning packet to the first application further comprises:
in response to the first positioning data received over the first time period reaching the first packet length and receiving a packet request from the first application, transmitting the first positioning packet to the first application via the first virtual port.

13. The location packet providing method of claim 11, wherein the step of transmitting the first positioning packet to the first application further comprises:
filtering out redundant data from the first positioning data based on a data setting to obtain filtered first positioning data; and
generating the first positioning packet based on the filtered first positioning data.

14. The location packet providing method of claim 11, further comprising:
receiving a plurality of second positioning data from a positioning signal source continuously, wherein the step of transmitting the first positioning packet to the first application further comprises:
in response to the first positioning data and the second positioning data received over the first time period reaching the first packet length, transmitting the first positioning packet with the first packet length to the first application via the first virtual port, wherein the first positioning packet comprises the first positioning data and the second positioning data received over the first time period.

15. The location packet providing method of claim 11, wherein the step of generating the second positioning packet further comprises:
in response to the first positioning data received over the first time period reaching the first packet length and receiving a packet request from the first application, generating the second positioning packet based on the first positioning data received over the second time period, wherein the second time period is later than the first time period.

16. The location packet providing method of claim 11, wherein the step of generating the second positioning packet further comprises:
in response to the first positioning data received over the second time period reaching the second packet length, transmitting the second positioning packet with the second packet length to the first application via the first virtual port, wherein the second positioning packet comprises the first positioning data received over the second time period.

17. The location packet providing method of claim 11, further comprising:
obtaining an amended packet length, wherein the amended packet length is determined based on the first application, and the amended packet length is different from the first packet length; and
determining the second packet length of the second positioning packet based on the amended packet length.

18. The location packet providing method of claim 17, wherein the amended packet length is obtained in response to the first application determining the first packet length is a wrong length and the first application transmitting the amended packet length via the first virtual port.

19. The location packet providing method of claim 17, wherein the step of obtaining the amended packet length further comprises:
generating a user interface, wherein the user interface comprises a plurality of packet length options; and
obtaining the amended packet length based on one of the packet length options selected in the user interface.

20. The location packet providing method of claim 11, further comprising:
transmitting a third positioning packet with a third packet length to a second application via a second virtual port among the at least one virtual port, wherein the third packet length is different from the second packet length.
